(19) United States
(12) Patent Application Publication
(10) Pub. No.: US 2023/0236319 A1
(43) Pub. Date: Jul. 27, 2023

(54) ACTIVE MARKER RELAY SYSTEM FOR PERFORMANCE CAPTURE

(71) Applicant: Unity Technologies SF, San Francisco, CA (US)

(72) Inventors: Dejan Momcilovic, Wellington (NZ); Jake Botting, Wellington (NZ)

(73) Assignee: Unity Technologies SF, San Francisco, CA (US)

(21) Appl. No.: 18/101,507

(22) Filed: Jan. 25, 2023

Related U.S. Application Data
(60) Provisional application No. 63/303,454, filed on Jan. 26, 2022.
(60) Provisional application No. 63/303,456, filed on Jan. 26, 2022.
(60) Provisional application No. 63/303,457, filed on Jan. 26, 2022.
(60) Provisional application No. 63/411,493, filed on Sep. 29, 2022.

(51) Int. Cl. G01S 17/42; G01S 17/894; G01S 17/50; G01S 7/497; H04N 5/222

(52) U.S. Cl. CPC G01S 17/42; G01S 17/894; G01S 17/50; G01S 7/497; H04N 5/2226

(57) ABSTRACT

An active marker relay system is provided to operate responsive active markers coupled to an object in a live action scene for performance capture, via a trigger unit that relays energy pulse information to responsive active markers. Using use simple sensors, the responsive active markers sense control energy pulses projected from the trigger unit. In return, the responsive active markers produce energy pulses that emulate at least one characteristic of the control energy pulses, such as a particular pulse rate or wavelength of energy. The reactivity of the responsive active markers to control energy pulses enables simple control of the responsive active markers through the trigger unit.

### CLAIMS OF PRIORITY AND INCORPORATION OF RELATED APPLICATIONS

This application claims the benefit of U.S. Provisional Patent Application Ser. No. 63/303,454, entitled OPERATION OF WIRELESS ACTIVE MARKERS FOR PERFORMANCE CAPTURE, filed on Jan. 26, 2022 (WD0165PP1), U.S. Provisional Patent Application Ser. No. 63/303,456, entitled ACTIVE MARKER RELAY SYSTEM FOR PERFORMANCE CAPTURE, filed on Jan. 26, 2022 (WD0165PP2), Provisional Patent Application Ser. No. 63/411,493, entitled ACTIVE MARKER ATTACHMENT FOR PERFORMANCE CAPTURE, filed on Sep. 29, 2022 (WD0165PP3), U.S. Provisional Patent Application Ser. No. 63/303,457, entitled DIRECTED RELAY SYSTEM FOR ACTIVE MARKERS IN PERFORMANCE CAPTURE, filed on Jan. 26, 2022 (WD0165PP4), which are all hereby incorporated by reference as if set forth in full in this application for all purposes.

### FIELD OF THE INVENTION

The present disclosure generally relates to virtual productions and more particularly to control of active markers in a live action scene for performance capture systems.

### BACKGROUND

Virtual productions often combine real and digital images to create animation and special effects. Such virtual productions can include movies, videos, clips, and recorded visual media. Performance capture (or “motion capture”) systems may be employed to obtain information about a physical object, e.g., an actor, on a location shoot, such as a person's shape, movement and facial expression. Energy, such as light, captured from active markers on objects in a live action scene may be used to create a computer-generated (“CG,” “virtual,” or “digital”) character. Energy released from the active markers is recorded to establish position, orientation, and/or movement of the objects to which the markers are attached. Virtual productions often involve much action and intricate movement by the objects being recorded. Recording of live action can require many costly “takes” if a shot is not right.

It may be desirable to employ wireless active markers for performance capture, for example when seeking flexibility in placement of the markers on objects or actors. Active markers for performance capture purposes should be configured to not impede the action of objects being recorded during a shoot. A wireless active marker is typically compact in size to avoid obstruction of the object to which they are attached. There is a balance between simplicity in design and the ability of a wireless active marker to be reliable and self-contained with necessary features. At times, it is beneficial for such wireless active marker to communicate with other components of the performance capture system over a variety of distances, such as about a 50 meter range, without other objects interfering with the communications.

### SUMMARY

An active marker system is provided to relay control energy pulses to responsive active markers coupled to an object in a live action scene associated with a virtual production. A trigger unit provides control energy pulses that responsive active marker units detect and respond by emitting energy pulses that emulate the control energy pulses.

In some implementations, a method is provided for operating active markers for performance capture employing a trigger unit positioned in a live action scene and proximal to one or more responsive active markers attached to an object in the live action scene. According to the method, the trigger unit emits control energy pulses of a first control set. The one or more responsive active markers sense the control energy pulses from the trigger unit. In response to sensing the control energy pulses, the one or more responsive active markers emit response energy pulses of a first response set. The response energy pulses of the first response set emulates at least one characteristic of the sensed control energy pulses. In some implementations, the at least one characteristic of the sensed control energy pulses includes at least one of a pulse rate or an energy wavelength.

The emitted response energy pulses are captured, by one or more sensor devices, the response energy pulses of the first response set. Marker data is generated based, at least in part, on the captured response energy pulses of the first response set. In some implementations, the control energy pulses are also captured by the one or more sensors and the marker data is also generated based on the captured control energy pulses.

In some implementations, sensing of the control energy pulses of the first control set is with a respective photodiode of the one or more responsive active marker. The emitting of the response energy pulses involves generating electrical current by the respective photodiode consistent with a pulse rate of the sensed control energy pulses. An energy source of the one or more responsive active markers responds to the electrical current by emitting the response energy pulses at the pulse rate.

In still some implementations, the control energy pulses of the first control set are emitted at a first pulse rate at a first time period and during a second time period control energy pulses of a second control set may be emitted from the trigger unit according to a second pulse rate that is different from the first pulse rate. The control energy pulses of the second control set are also sensed by the responsive active marker, and in response, response energy pulses of a second response set may be emitted by the responsive active marker. The response energy pulses of the second response set may emulate the second pulse rate of the sensed control energy pulses of the second control set. The one or more sensor devices may further capture the response energy pulses of the second response set.

Further to this implementation including multiple control sets, a first mode of operation may be determined by the trigger unit and the control energy pulses of the first control set may be emitted in response to determining the first mode of operation. The trigger unit may also determine a second mode of operation and emit a second control set of control energy pulses in response.

Further to the multiple control set implementations, the control energy pulses of the first control set may include a first wavelength of energy and the response energy pulses of the first response set may emulate the first wavelength of energy. In addition, the control energy pulses of the second control set may include a second wavelength of energy different from the first wavelength of energy, and the response energy pulses of the second response set may emulate the first wavelength of energy. In some implementations, the trigger unit may determine environmental conditions and may select the first wavelength of energy based on a determined first environmental condition. Accordingly, the second wavelength of energy may be selected based on a determined second environmental condition.

An active marker relay system may be provided that includes a trigger unit positioned in a live action scene and proximal to one or more responsive active markers on an object in the live action scene, the trigger unit includes one or more energy sources, such as one or more light sources, to emit control energy pulses of a first control set according to a pulse rate. The one or more responsive active markers include one or more sensors to detect the control energy pulses. The one or more responsive active markers also include one or more energy sources to emit response energy pulses of a first response set, responsive to the detected control energy pulses of the first control set. The emitted response energy pulses of the first response set emulate the pulse rate of the detected control energy pulses. The relay system may further one or more sensor devices to capture the response energy pulses of the first response set and a computing device to generate marker data based on the capture the response energy pulses of the first response set.

The one or more sensors of the respective one or more responsive active markers may include a photodiode to generate electrical current by the photodiode consistent with the pulse rate of the detected control energy pulses. As such, the one or more energy sources may be configured to respond to the electrical current by emitting the response energy pulses at the pulse rate.

In some implementations, the trigger unit may further include a processor to execute logic to perform operations such as determining a mode of operation and directing the one or more energy sources to emit control energy pulses at an adjusted pulse rate in response to determining the mode of operation. The trigger unit may also include a condition sensor that senses one or more characteristics of an environment. The operations performed by the through executing logic may include determining the environmental condition based on the one or more characteristics and selecting a wavelength of the control energy pulses based on the environmental condition.

In some implementations, the relay system may also encompass a signal controller having a transmitter to transmit signals indicating a pulse rate to the trigger unit. In such configurations of the relay system, the trigger unit may have an antennae to receive the signals from the signal controller.

The active marker relay system may additionally comprise a control unit, and the trigger unit may receive the pulse rate through wired communication with the control unit.

In still some implementations, the one or more energy sources of the responsive active marker may include one or more first energy sources to emit a first wavelength of energy in response to at least one of the one or more sensors detecting control energy pulses of the first wavelength, and one or more second energy sources to emit a second wavelength of energy in response to at least a second one of the one or more sensors detecting control energy pulses of the second wavelength.

In some implementation, a method is provided for operating active marker units in a live action scene for performance capture in which a trigger unit that is positioned proximal to one or more responsive active markers attached to an object in the live action scene, emits control energy pulses at a pulse rate. The one or more responsive active markers sense the control energy pulses during a first time period and during a second time period. In response to detecting during the first time period, the one or more responsive active markers may emit response energy pulses of a first response set during the first time period, which emulate a first subset of the detected control energy pulses. In response to detecting during the second time period, the one or more responsive active markers may also emit response energy pulses of a second response set during the second time period. The response energy pulses of the second response set may emulate a second subset of the detected control energy pulses. The first subset and the second subset may be different subsets of the detected control energy pulses. The one or more sensor devices may capture the response energy pulses of the first response set and the second response set

In such method, the response energy pulses of the first response set may indicate a first mode of operation and the response energy pulses of the second response set may indicate a second mode of operation. Furthermore, the responsive active marker may receive mode indicator energy pulses from the trigger unit to indicate at least one of the first mode of operation or the second mode of operation. In some implementations, the one or more sensor devices may capture the control energy pulses of the control set and marker data may be generated by the performance capture system based on the captured control energy pulses.

A further understanding of the nature and the advantages of particular implementations disclosed herein may be realized by reference to the remaining portions of the specification and the attached drawings.

### BRIEF DESCRIPTION OF THE DRAWINGS

Various implementations in accordance with the present disclosure will be described with reference to the drawings.

FIG. 1 is a block diagram of an example of a virtual production system for generating images of visual elements, in which a trigger unit is positioned within a live action in proximity to responsive active markers, in accordance with some implementations.

FIG. 2 is a cutaway side view schematic diagram of an example of a responsive active marker, in accordance with some implementations.

FIG. 3 is a cutaway side view schematic diagram of an example of a trigger unit, in accordance with some implementations.

FIG. 4 is a side perspective view diagram of an actor wearing an active marker relay system including a trigger unit, wireless responsive active markers, and a control unit, in accordance with some implementations.

FIG. 5 is a flowchart of an example method for operating responsive active markers using a trigger unit, in accordance with some implementations.

FIG. 6 is a flowchart of an example method for operating responsive active markers that selectively respond to sensed control pulses, in accordance with some implementations.

FIG. 7 is a block diagram illustrating an example computer system upon which computer systems of the systems illustrated in FIG. 1 may be implemented, in accordance with some implementations.

FIG. 8 illustrates an example visual content generation system as might be used to generate imagery in the form of still images and/or video sequences of images, in accordance with some implementations.

### DETAILED DESCRIPTION

In the following description, various implementations will be described. For purposes of explanation, specific configurations and details are set forth in order to provide a thorough understanding of the implementations. However, it will also be apparent to one skilled in the art that the implementations may be practiced without the specific details. Furthermore, well-known features may be omitted or simplified in order not to obscure the implementation being described.

The present active marker relay system facilitates operation of active marker units in a live action scene by employing a trigger unit to emit control energy pulses that are sensed by responsive active markers. In reaction, each responsive active marker emits response energy pulses that emulate particular aspects e.g., “characteristics”, of the sensed control energy pulses. Such characteristics may include a particular pulse rate, wavelength of energy, intensity of the energy pulse, duration, etc. In some implementations, the response energy pulses may fully mimic the sensed control energy pulses to include the same characteristics and appear the same. The response energy pulses are captured by the performance capture system to generate marker data. Such marker data is used to track movement, position, and/or orientation of objects to which the active markers are attached.

The responsive active marker uses a simple, fast reacting sensor, such as a photodiode, to generate, activate, deactivate, or otherwise modulate electrical current that controls emission of energy pulses from the responsive active marker. In this manner, the responsive active markers unit need not decode complicated signals, such as radiofrequency signals, to control various aspects of energy emissions, such as turning on/off the energy emissions, determining a pulse rate, intensity, and/or wavelength of energy to emit. For example, the responsive active marker may sense control pulses at a particular pulse rate from a trigger unit and sensing of the control pulses triggers the responsive active marker to emit energy pulses at the same characteristic pulse rate as the control pulses.

In some implementations, the responsive active marker responding to the control energy pulses occurs within a very short time lapse as each control pulse is sensed, e.g., milliseconds, providing an effect that the energy pulses of both the trigger unit and the responsive active marker are concurrently emitted. The term, “real time” as used herein includes near real time and refers to simultaneous occurrences or occurrences substantially close in time such that they appear to be simultaneous.

In some implementations, a responsive active marker may selectively respond to particular control pulses in a control set of pulses from the trigger unit in a controlled manner. For example, the responsive active marker may sense or respond to only select pulse patterns and/or predefined wavelengths of the control pulses. In such implementations, rather than emulate each pulse of the control energy pulses, a responsive active marker may emulate particular control pulses and ignore other control pulses. For example, a responsive active marker may emulate every other control pulse, every two control pulses, and other combinations and sequence of pulses to emit variable energy pulses of a response set of pulses.

In some implementations, variable energy pulses from a responsive active marker may indicate certain conditions or characteristics of the responsive active marker. A variable energy pulse may indicate problems with operations and/or components of the responsive active marker. A variable energy pulse may also be indicated a responsive active marker identification.

The response energy pulses from a responsive active marker and the control pulses from a trigger unit may include various wavelength frequencies on a spectrum, such as electromagnetic radiation, for example, infrared radiation, ultrasonic radiation, visible light, radio waves, etc. In some implementations, the energy pulses may be in the form of sonar energy. In some implementations, the trigger unit may emit a particular wavelength and the responsive active marker emits the same wavelength of energy. In some implementations, the trigger unit may emit a certain wavelength of energy and the responsive active markers emit a different wavelength of energy.

The present relay system may employ wireless active markers, such as the responsive active markers. In some implementations, the trigger unit may also be a wireless active marker. Wireless active markers operate without wired connections to other component of the relay system, such as a control unit and/or other active marker units. A wireless active marker unit includes onboard essential features and components for operation of the wireless active marker unit.

Wireless responsive active markers may be simplistic and compact in design with limited memory capacity and electronics. For example, an onboard 5D data storage crystal may be small in size with restricted capacity to hold data encoding an energy pulse rate for a long time. A wireless active marker relying solely on prestored pulse rates may drift out of sync.

In some implementations, an active marker attachment system may be provided to enable precision in securely fixing active markers to a wearable article of an object and accessibility of active markers during a performance capture recording session. The active marker attachment system facilitates reliable fastening of an active marker unit to a wearable article intended to be worn by an object that is a subject of a recording session. The attachment system may include an active marker unit having various portions to house components and a locking mechanism to the active marker unit attach to a wearable article. For example, a protrusion portion of the active marker unit may hold energy sources and a base portion of the active marker unit may enable positioning of the protrusion portion to the exterior of the wearable article via the locking mechanism.

In some implementations of an attachment system, certain portions may be detachable from other portions of the active marker unit to avoid disrupting the position of the base portion on the wearable article. For example, when the base portion is fastened to the wearable article, the protrusion portion and/or a central portion of the active marker unit may be removed and replaced or reinstalled while the base portion remains intact on the wearable article. Some examples of such an active marker attachment system is described in U.S. Provisional Patent Application No. 63/411,493, filed on Sep. 29, 2022, the contents of which is incorporated herein by reference.

It is important for wireless active markers to emit energy in sync with other performance capture devices. If the emitting of energy becomes too far off the sync and fails to synchronize with other components, such as a sensor device, the energy may not be accurately captured and/or identified as coming from a particular active marker. Wireless responsive active markers can use detected control pulses as a dependable source of pulse control, instead of, or in addition to pre-loaded energy pulse rates.

The wireless configuration enables the object to which wireless active markers are attached to freely move in the live action scene with reduced risk of obstruction and without tangling of wires. Wireless active markers, e.g., responsive active markers, may be placed on a variety of objects of different sizes, such as a weapon, without needing to cable the active marker to a bulky control unit. Groups of wireless active markers may also be placed anywhere on an object. Groups of wireless active markers need not be restricted to particular lengths of wired strands (e.g., small, medium, and large) that hold wired active markers and can accommodate objects, e.g., actors, of various sizes.

In some implementations, the control energy pulses emitted from the trigger unit may be available for detection by one or more sensor devices to provide performance capture information.

In some implementations, the trigger unit may also be a wireless active marker that may be larger in size than the responsive active marker units, and includes additional features for communication, memory, processing capacity, etc. However, in some implementations, the trigger unit may be wired to a control unit, such as master units positioned on an object in the live action scene also bearing the responsive active markers. In such a configuration, the responsive active marker units may be wireless and only the trigger unit may be wired. Such a trigger unit is positioned in the live action scene and serves a dual purpose of communicating energy pulses to responsive active marker units and as an energy pulse source for the performance capture system to detect and generate marker data.

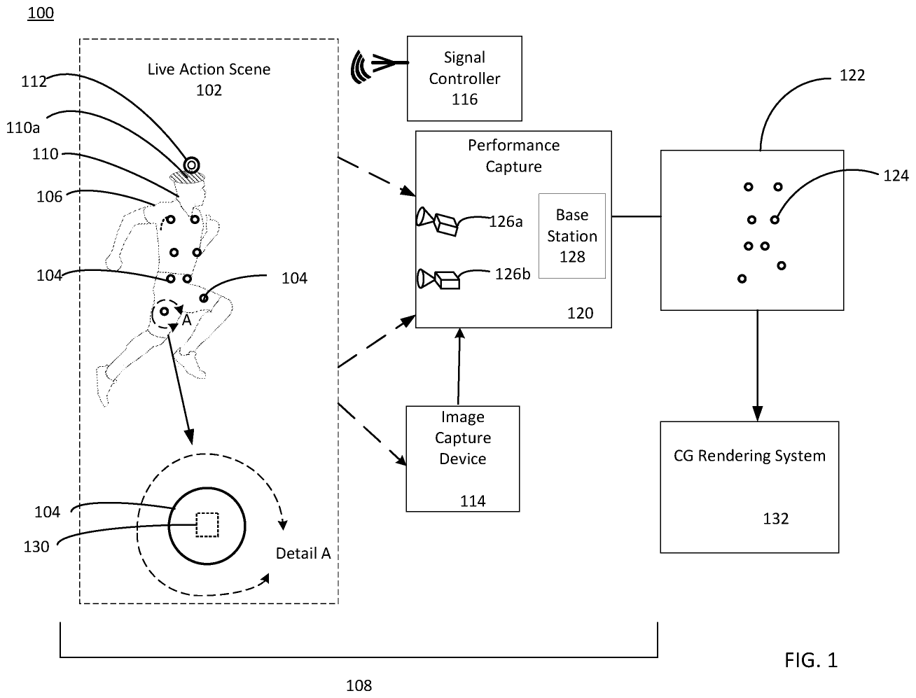

Other benefits of the active marker relay system will be apparent from the further description of the system, as described below. For example, responsive active markers may benefit from preserved battery life by controlled energy pulses that are emitted only when needed and may rest when not needed, such as when a responsive active marker is out of a field of view of a sensor device (e.g., 126a, 126b in FIG. 1 below) and/or image capture device (e.g., 114 in FIG. 1 below).

Various components of a virtual production system that can employ the active marker relay system, may include (1) live action components such as the active marker relay system that includes the active markers, the performance capture system, and an image capture device for generating marker data and images from a live action scene, (2) virtual production components for generating CG graphic information based on the marker data and images, and (3) content compositing components for generating output images. Any of the virtual production system components may communicate with the other components through a network or other data transfer technologies.

As shown in FIG. 1, a virtual production system 100 employs a performance capture system 120 to detect energy emitted from a plurality of responsive active markers 104 of an active marker relay system 108 in a live action scene 102. The live action scene 102 defines a volume available for recording objects (e.g., actors, props, set design, etc.) within the space, which may be depicted in images. Final output images produced by the virtual production system 100 may include depictions of the various objects and scenery from the live action scene 102 and computer graphics created with the use of detected energy from responsive active markers 104, and, in some implementations control energy from one or more trigger units 112. The live action scene 102 may include various settings, such as a motion production set, a performing stage, an event or activity, a natural outdoor environment, etc.

The trigger unit 112 emits control energy pulses that the responsive active markers 104 detect. Often, the trigger unit is positioned within the live action scene 102 in proximity to the responsive active markers 104 or otherwise in a typically unobstructed detection path from the responsive active markers 104. The trigger unit 112 is positioned to ensure an optimal chance that control energy pulses emitted by the trigger unit 112 are detected the responsive active markers 104. For example, the trigger unit 112 may be positioned on a same object 110 that bears the responsive active marker. For illustration purposes, FIG. 1 depicts the trigger unit 112 positioned on a headgear type wearable article 110a of the object 110 bearing the responsive active markers 104.

In some implementations, the trigger unit 112 may also be located in the live action scene 102 away from the object 110 or outside of the live action scene 102 and in a typically unobstructed detection path from the responsive active markers 104. In some implementations, the trigger unit 112 may also be positioned to enable the control energy pulses to be captured by the sensor devices 126a, 126b of the performance capture system for use in generating marker data. Such a trigger unit may serve a dual purpose of communicating control energy pulses to responsive active markers and providing an energy pulses for the performance capture system to detect and generate marker data.

In still some implementations, the trigger unit may be coupled to, or otherwise associated with the image capture device. The image capture device, also referred to as a picture camera, records the visible scene, including objects and scenery within a field of view during a shoot. In such implementations, the trigger unit coupled to the image capture device may adjustably project control energy pulses to a field of view of an image capture device, in which the active markers are located. The directed control energy pulses are sensed by active markers located in the field of view, which respond by emitting energy pulses that emulate the control energy pulses. Some examples of such implementations are described in U.S. Provisional Application No. 63/303,457, filed on Jan. 26, 2022, the contents of which is incorporated herein by reference.

In some implementations, the trigger unit may be wired to a control unit and receive energy pulse data and/or power through the wired connection with the control unit. In such a configuration, the responsive active markers may be wireless and the trigger unit may be wired.

The responsive active markers 104 may be coupled to the object 110, such as a person, via a wearable article 106 (e.g., a shirt and pants) in the live action scene 102. In some implementations, responsive active markers 104 may directly adhere to the object 110 such as with adhesive, or be integrated with the object 110. For the purposes of the present discussion, an object 110 in a live action scene may be any physical object that can bear the responsive active markers 104 (and in some cases also trigger units 112). For example, objects can include persons (such as actors), inanimate items (such as props), animals, plants, any part thereof, etc.

A wearable article 106 securing the active marker units may be any item covering at least a portion of the object in the live action scene, such as a garment, shoe, accessory, hat, glove, strap, cover, etc. For example, the wearable article may be a skin-tight suit made of elastic fabric.

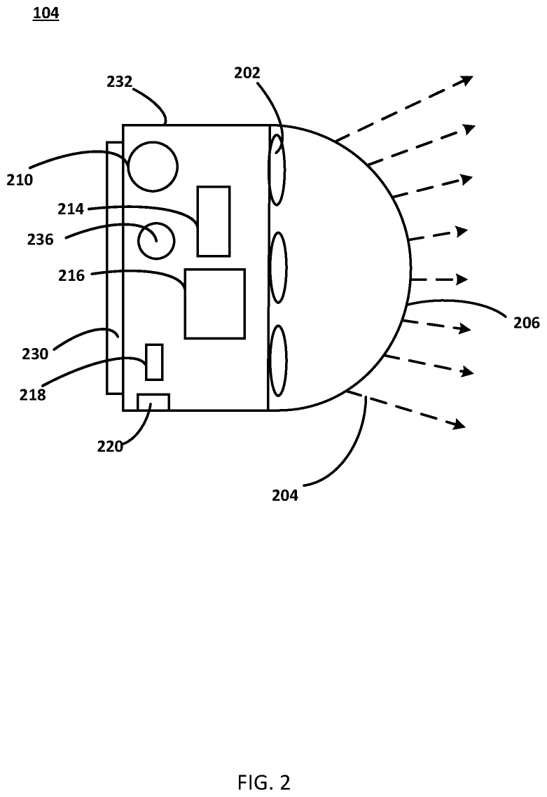

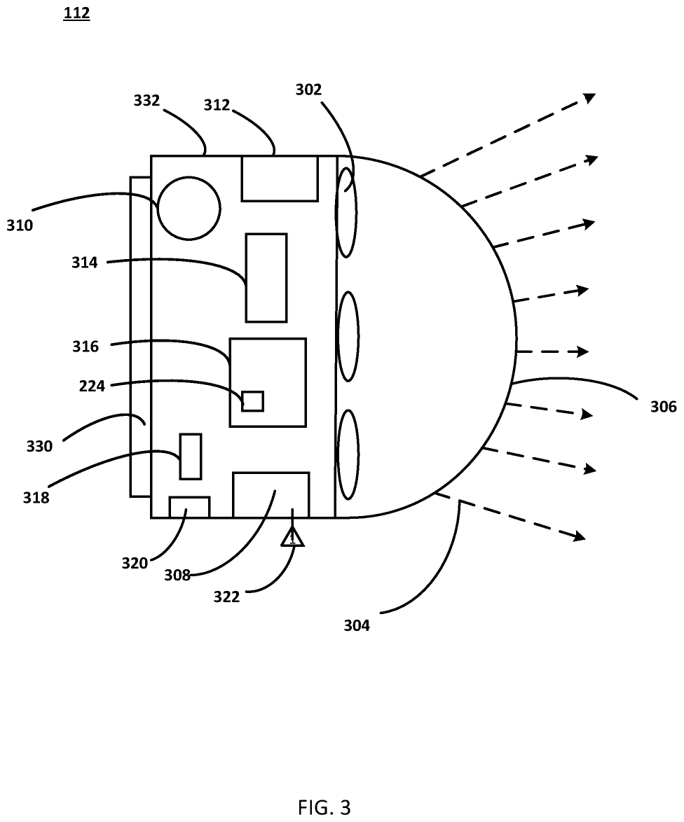

Individual responsive active markers 104 and trigger unit 112 contain active marker energy components shown in detail in FIGS. 2 and 3, respectively. The active marker energy components reside within a housing that includes an energy source 130 (as shown in the view Detail A) of energy that is captured by sensor devices 126a, 126b of the performance capture system 120 to generate marker data indicating information about the objects to which the markers are attached, e.g., position, orientation, shape, and/or movement of the object 110 and used by the CG rendering system 132 for animation.

The energy source 130 may include one or more energy producing devices, such as an LED or an array of a plurality of LED's (e.g., a bundle of three LED's). Any frequency of energy, e.g., electromagnetic radiation, may be selected to be produced by the energy source 130. For example, a particular wavelength range of light may be selected within various types of visible light and non-visible light, such as infrared, ultraviolet radiation, etc. In some implementations, the energy source may be one or more light emitting diode (LED) that radiate infrared wavelength light, such as between 700 nm and 1 mm, such as 850 nm.

In some implementations, a different wavelength of light may be produced by different energy sources 130, e.g., infrared and visible light sources. and/or result from use of various filters to emit particular wavelengths, wavelength ranges, or combinations of different wavelengths for the responsive active markers. A particular wavelength may be required under various live action scene conditions, such as fog, or based on a resolution and optical contrast may require a responsive active marker. For example, an energy source 130 that emits blue wavelength light or sonar energy may be used for high moisture or water settings. In some implementations, a live action scene may include multiple responsive active markers that emanate different wavelengths of light. For example, an object may include groups of active marker units that each disperses distinctive wavelengths of light. In some implementations, the trigger unit 112 may emit one wavelength or type of energy at a particular pulse rate and the responsive active markers 104 may respond by emitting a different wavelength or type of energy at the same pulse rate. The trigger unit 112 may employ the same or similar selection of wavelengths of energy to emit, as described for the responsive active marker 104.

In some implementations, a responsive active marker 104 and/or trigger unit 112 may include a multi-band emitter by which the active marker may be configured to emit various wavelengths ranges of energy at any given time, such as at the same time or at different times. For example, an active marker energy component may include a plurality of energy sources that are configured to emit a particular wavelength of energy at one time and emit a different wavelength of energy at a different time. In some implementations, the trigger unit 112 may receive energy changing control signals, such as radio frequency waves encoded with energy pulse data, from a signal controller 116 to specify a particular wavelength of energy the trigger unit is to emit at any given time.

In some implementations, the trigger unit may change the wavelength of emitted energy in response to condition sensors on the active marker unit or scheduled according to a script. A condition sensor may detect particular characteristics of an environmental condition, which may be used by the trigger unit processor to determine the environmental condition associated with the characteristic and further to determine a particular wavelength of energy is favorable or unfavorable under such a condition. For example, the environmental condition may include interfering or poor environmental lighting, which the condition may sense as a bright light or conflicting wavelength of light in the live action scene. Other environmental conditions are possible, such rain, fog, submersion in water, and the like, detected by a corresponding moisture level by the condition sensor.

The trigger unit may automatically generate the favorable wavelength of energy based on conditions detection by the condition sensor. In some implementations, the trigger unit 112 may direct the responsive active markers 104 to emit particular wavelengths of energy. For example, the trigger unit 112 may vary the wavelength of the control energy pulses and the responsive active markers 104 may detect the wavelength change and make changes to energy pulses the responsive active marker emits, accordingly. In some implementations, the responsive active marker may include a variety of energy sources that emit different wavelengths of light and detecting control energy pulses of a particular wavelength may trigger the energy source that emits a corresponding wavelength of energy.

In some implementations, a multi-band emitting active marker energy component may emit various wavelengths of energy at the same time via different energy sources or filters within the active marker energy component. For instance, a first wavelength of light may emanate from one part of the multi-emitting active marker unit, such as a front side, and a second wavelength of light may simultaneously emanate from a different part of the multi-emitting active marker unit, such as a backside. In some implementations, the different types of energy sources may point to different areas of the multi-emitting active marker unit to emanate from different sides.

Multiple-band emitters may be especially useful when conflicting energy is present on a set e.g., environmental light, which interferes with some wavelengths of light of an active marker unit, but not interfere with other wavelengths. Multi-band emitters may also provide information about the active markers, such as location, 3-D direction the marker is facing, identification of the active marker and/or object, etc.

In some implementations, one wavelength or range of wavelengths of energy may emanate from the multi-emitting active marker unit at a first time period. Then at a second time period a different wavelength or range of wavelengths of energy may emanate from the same multi-emitting active marker unit. The multi-emitting active marker unit may be controlled to emanate particular wavelengths of energy based on various factors, such as environmental conditions, sensor technology employed to capture the energy, according to a pre-defined time schedule for the various wavelengths of energy, for a particular scene and/or object being shot, etc.

The trigger unit 112 may generate and emit energy according to a predefined pulse rate. For example, the trigger unit 112 may receive energy pulse data encoded into signals, such as radio frequency waves, transmitted by signal controller 116. The signal controller 116 generates signals that indicate a pulse rate and transmits the signals by a transmitter of the signal controller to a receiver on the trigger unit 112. In this manner, the trigger unit 112 and as a result, the responsive active markers 104 may be directed to emit energy according to the pulse rate. In some implementations, the signals may be transmitted in periodic intervals rather than a constant transmission. The periodic intervals may be timed to avoid interference with other signals of a similar frequency in the location of the live action scene and recording session. For example, a vehicle alarm maybe of a similar frequency and the signal may interfere with remote unlocking of the vehicle. The gap of time between intervals of the signal may allow for the automobile to be unlocked.

The signal controller 116 is typically located away from the object and outside of the live action scene rather than being positioned on the object to which the responsive active markers are attached. The active marker relay system 108 may be placed at a distance from the signal controller 116 that enables the trigger unit 112 to receive signals. For example, the active marker relay system 108 may be located up to 50 m from the signal controller 116.

In some implementations, the pulse rate of energy emitted from the trigger unit 112 may be in synch with global shutter signals and according to the signal controller 116. In some implementations, the pulse rate signals from the signal controller 116 may include radiofrequency signals to transmit information. In some implementations, the signal from the signal controller 122 is a global pulse rate that operates in a low bandwidth, e.g., a ZigBee communication system at a 900 megahertz or 915 Mhz range signal, and narrow bandwidth, e.g., less than 20 Khz, in compliance with power regulations for the band.

In some implementations, signal controller 116 may also release signals to direct an action by the performance capture system 120 to drive capture by the sensor devices 126a, 126b at the same time as the pulse rate of energy from the responsive active markers 104. For example, the pulse rate may be calibrated to be consistent with the sensor device 126a, 126b exposure time so that energy is emitted from the responsive active markers 104 and/or trigger unit 112 when the sensor device shutter is open and not when the shutter is closed. The use of a pulse rate rather than constant emitting of energy may provide a benefit in reducing energy needs, preserve battery life, and differentiate the emitted energy from constant sources of interfering energy at live action scene.

In some implementations, the energy pulse rate is detectable by the sensor devices of the performance capture system within a single cycle of the image capture device. In the example shown, the performance capture device may detect the pulse rate multiple times within a single cycle of the image capture device. In some implementations, the pulse rate may consist of energy periods and gap periods during an illuminated frame or time slice. Individual frames of the performance capture system may include illuminated frames in which energy is detected from the active markers and blank frames in which no energy is detected and it is determined that no energy is present or emitted by an active marker. The performance capture system 130 may recognize an illuminated frame as depicting energy, independent of the length of the period of energy and the length of any gap that occurs during exposure of the frame. Thus, the length of time of the energy period does not impact the result so long as the energy period is sufficient for the sensor device to capture some energy.

The pulse rate, for example, may include sequential repeated on and off frames, such as illuminated frame is followed by blank frame, which is repeated for subsequent frames and ending with blank frame. In some implementations, the pulses may occur across any number of frames according to a pattern, such as light during two frames, off for two frames, or two illuminated frames and blank for one frame, which pattern repeats in subsequent frames.

In some implementations, the trigger unit 112 may be pre-loaded with an internal reference for the pulse rate and the trigger unit may synchronize with the internal reference. For example, prior to the production shoot, the trigger unit 112 may communicate via a wired or wireless mechanism, with a base station 128 of the performance capture system 120. In some implementations, the base station 128 may feed energy pulse rate including rate of energy pulses and duration, e.g., using SMPTE (Society of Motion Picture and Television Engineers) standards, via genlock to the individual trigger unit 112, according to a time code. Other devices of the virtual production system, such as sensor devices, signal controller, and image capture devices may be similarly synchronized, e.g., using genlock. Jam syncing via a phase lock device may provide the trigger unit with the energy pulse rate to store in memory by generating a reference block. In some implementations, the responsive active markers 104 may also store an internal reference. However, the limited storage capacity of the responsive active markers may lead to variability in the stored energy pulse rate over time. Such synchronization may enable energy to be captured in predicable frames of the sensor devices, within distinct time slices that depict a predefined energy pulse rate.

The sensor devices 126a, 126b, e.g., cameras, may be configured to capture at least one particular wavelength of energy from the responsive active markers 104 and trigger unit 112. In some implementations, one or more sensor devices 126a, 126b of the performance capture system 120 may include a visible light filter to block visible light and allow only particular wavelengths of non-visible light to be detected by the sensor devices 126a, 126b. The sensor device 126a, 126b may include various types of cameras, such as a computer vision camera and mono-camera that is sensitive to infrared light (700 nm to 1 mm wavelength light), e.g., that exclude infrared blocking filters. In some implementations, different wavelengths of energy may be captured by different sensor devices. In some implementations, one sensor device may include separate components to detect two or more different wavelengths of energy by the same sensor device.

For illustration purposes, two sensor devices 126a, 12b are shown in FIG. 1. However, one or more sensor devices may be employed to detect energy pulses from any given responsive active marker, and in some cases, detect control energy pulses from a given trigger unit. At least two sensor devices are used to determine three dimensional (3-D) marker data of the objects in the live action scene, from the detected energy pulses.

In some implementations, the performance capture system may detect energy emitted from a responsive active marker and represent the captured energy in predesignated detection image frames of the performance capture system, regardless of the amount of energy emitted, e.g., number of photons, by the responsive active marker over a given time block. A trigger threshold of energy may cause the performance capture system to register that a presence of energy from a responsive active marker is detected. In some implementations, a trigger threshold of light may include a level of contrast of illumination or light intensity of the pixels of a light patch in an image compared to an intensity of an area of pixels, e.g., one or more pixels, surrounding the light patch in the image captured by the performance capture system. In some implementations, the present performance capture system need not quantify a value for an intensity of energy to determine a presence of energy, but rather uses a comparison of the pixels representing the energy with pixels proximal to the light pixels. Thus, the present performance capture system enables a simplified technique to detect active marker energy. In some implementations, the trigger threshold may be a threshold size of the light patch captured in a given time block. In some implementations an energy pulse rate may consist of regular on and off cycles per frame.

In some implementations, an image capture device 114, e.g., a picture camera or “hero” camera, captures visible light, such as actors, scenery, and props in the live action scene. In some implementations, the image capture device 114 and sensor devices 126a, 126b may be synchronized. Data from the image capture device 114 and the sensor devices 126a, 126b may be combined to determine a marker arrangement 122 of responsive active markers 104 from energy emitted and captured from a plurality of responsive active markers 104 and trigger unit 112. The performance capture system determines the marker arrangement 122 from data 124 representing positions of the detected markers. The marker data from the image capture device may also be used to match CG parameters for CG images with image capture device parameters, such as perspective, position, focal length, aperture, and magnification, of the CG images. In this manner the CG images may be created in an appropriate spatial relationship with the live action objects.

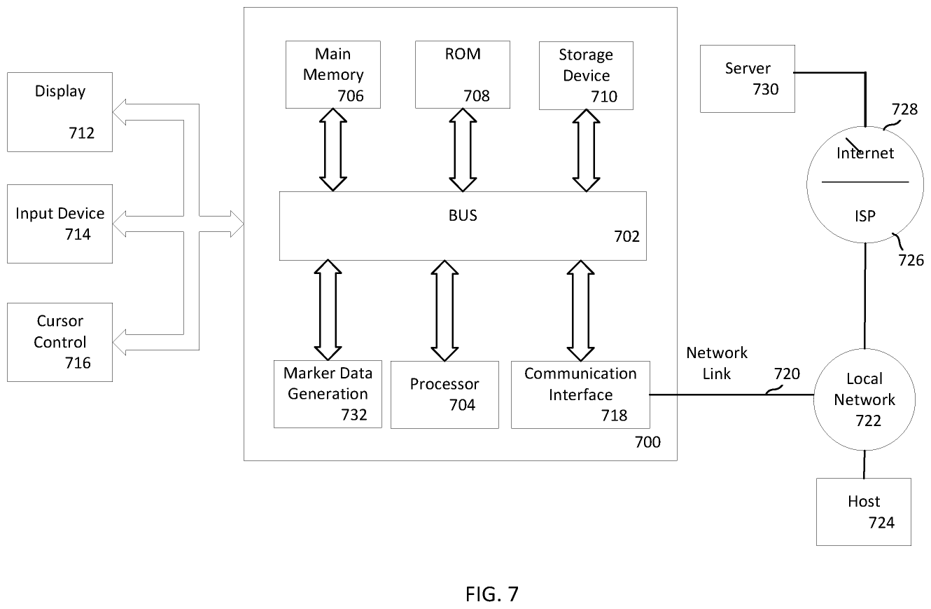

The performance capture system 120 feeds marker data obtained from the detection of the active marker units 104 to the CG (computer graphics) rendering system 132 to be mapped to a virtual model using software of the CG rendering system 132. The CG rendering system 132 may represent the data in a virtual environment. For example, computer programs may be used by CG rendering system 132 to overlay information on top of movements of the object 110 represented by the data. The CG rendering system 132 may include computer processing capabilities, image processing capabilities, one or more processors, program code storage for storing program instructions executable by the one or more processors, as well as user input devices and user output devices (e.g., animation and rendering components of computer system 700 described below with regard to FIG. 7).

The virtual production system in FIG. 1 is a representation of various computing resources that can be used to perform the process actions and steps described herein. Any number and type of discrete or integrated hardware and software components may be used. The components may be located local to, or remote from the other system components, for example, interlinked by one or more networks.

As shown by the schematic diagram example of a responsive active marker in FIG. 2, the responsive active marker 104 may be a self-contained and wireless active marker. Thus, the responsive active marker 104 includes onboard essential components including a housing 232 and including energy sources 202, an attachment mechanism 230, drive electronics, a power source 210, and a sensor 236. In some implementations, the responsive active marker may also include one or more processors 214, memory 216, and a controller 218. The sensor 236 may be a photodiode or other fast reacting energy sensor to detect control energy pulses from the trigger unit.

Sensor 236 is a fast reacting energy sensor, such as a light sensor, e.g., photodiode, phototransistor, photovoltaic cell, etc., or other type of sensor that is configured to quickly detect control energy pulses to generate electrical current sufficient to regulate emission of energy pulses. Simple circuitry onboard the responsive active marker 104 may include various amplifiers, switches, resistors, etc. In some implementations, the sensor 236 detecting control energy pulses from the trigger unit results in the responsive active marker emulating the detected control energy pulses to mimic the pulses. In some implementations, sensor 236 may be associate with a filter to selectively detect particular wavelengths of energy.

In some implementations, sensor 236 may include more than one sensor in which at least one sensor is configured to detect a particular wavelength of the control energy pulse. The responsive active marker may include additional the sensors, each configured to detect a different wavelength of the control energy pulses. The sensors may be sensitive to particular wavelengths by employing various materials, e.g., silicon, germanium, indium gallium arsenide, etc., and/or use of various filters. Wavelength specific sensors may be wired to particular energy sources that are configured to emit the detected wavelength of energy.

The energy source 202, which emits energy pulses 204 for detection, may be one or more infrared LED's, such as an array of a plurality of LED's 202 (e.g., a bundle of three LED's). Various wavelengths may be emitted by the energy source 202, e.g., between 700 nm and 1 mm, or more specifically between 800 nm and 960 nm. For example, the energy source can be a 940 nm wavelength, 1 watt infrared (IR) LED. However, other wavelengths are possible, such as ultraviolet wavelengths from the energy source 202 and the sensor device is an ultraviolet detector. In some implementations, various wattage energy sources may be employed depending on the live scene of the shoot. For example, higher wattage may be used when shooting in bright daylight and lesser wattage for dark scenes. The strength of the energy, power, pulse rate, and duration of each energy pulse may depend of various factors, such as distance, environmental light conditions, etc.

Distinctive types of energy sources may be separately gated to emit energy in response to detecting control energy pulses. In response to sensor 236 detecting control energy pulses the responsive active marker circuitry components may actuate particular energy sources to emit different particular wavelengths of light at different times or according to various modes of operation of the responsive active marker, such as diagnostics mode, calibration mode, and standard operation mode. For example, a responsive active marker emitting a red wavelength light may indicate a particular mode of operation or condition of the responsive active marker and a green wavelength light may indicate another mode of operation, such as a mimic pulse in standard operation mode.

In some implementations, the responsive active marker may have components that enable selective and/or varied response upon detection of the control energy pulse. The circuitry may generate current to direct the energy source 202 to pulse in mimicry of a predefined subset of detected control energy pulses. For example, the emulating of control energy pulses with responsive active marker energy pulses may occur for every other energy control pulse detected, every two energy control pulses, or combination repeating patterns, such as emulating every other control pulse, then every two control pulses.

In some implementations, the selective response by the responsive active marker may correlate with a detected mode of operation of the responsive active marker. For example, the responsive active marker may detect a calibration mode and the responsive active marker may flash in response to a first subset of control pulses, such as every second time it receives a control energy pulse. In another example, a diagnostics mode may be detected, and during the diagnostic mode the responsive active marker may respond to a different subset of control pulses, such as every two control pulses may trigger the responsive active marker to emit a single energy pulse. In still another example, detection of a standard operating mode may trigger the responsive active marker to mimic every control energy pulse that the responsive active marker senses.

In some implementations, the trigger unit may detect a specific mode of operation. The responsive active marker may receive a signal, such as a mode indicator energy pulse, from the trigger unit to indicate to the responsive active marker the mode of operation. The mode indicator energy pulse may be distinguished from a control energy pulse, such as a different wavelength of energy. By the responsive active marker receiving information about a current mode of operation from the trigger unit, the responsive active marker may not be required to store onboard the modes of operation. The trigger unit may receive the mode of operation through signals received by the trigger unit from a signal controller.

Emitted energy 204 from the energy source 202 passes through a diffuser 206, which includes at least one surface that is transmissive to the wavelength of energy emitted by the energy sources 202. The diffuser 206 may be any shape that enables detection of a wavelength or a range of wavelengths of energy passing through the diffuser, such as hemisphere or sphere shape.

In some implementations, the diffuser 206 enables controlled disbursement of energy through various surfaces of the diffuser that have different transmissivity properties for assorted wavelengths of energy. For example, a portion of the diffuser 206 may be transmissive to a first wavelength range of energy and block other wavelengths of energy. A separate portion of the diffuser 206 may be transmissive to a second wavelength range of energy but block other wavelengths (e.g., the first wavelength range). In this manner, the diffuser 206 may serve as a filter to selectively permit one or more particular wavelengths of energy to emanate from the responsive active marker.

In some implementations, opaque portions of the diffuser 206 may block energy emitted from the energy sources, such that the energy only diffuses through the transmissive surfaces of the diffuser 206. In this manner, energy may be directed to emanate from the responsive active marker in particular directions and/or to form specific shapes of energy points for detection. In some examples, a periphery of the diffuser may be opaque to focus the energy to disperse from a central transmissive portion. Focusing of light by the diffuser may avoid light reflecting off of the object to which it is attached or other leakage of the light.

In some implementations, particular energy pulse rates and/or pulse patterns may be associated with given responsive active markers for identification of the active marker unit. For example, the performance capture system may access a database that associates a pulse rate and/or pulse pattern to a particular responsive active marker or group of responsive active markers. The database may further associate the responsive active marker identification to an object or part of an object, e.g., right knee of an actor, to which the responsive active marker is attached.

In some implementations, a plurality of trigger units are provided, each being dedicated to particular groups of responsive active markers, as identifiable by unique patterns of control energy pulses for each trigger unit. If the energy emitted from a responsive active marker is too far off from a predefined energy pulse rate, the sensor device may not capture the emitted energy. For example, a sensor device may be shut during the emitted energy pulse. Identification of a responsive active marker may also become disrupted if a responsive active marker is significantly out of sync and the emitted energy is not detected in the predicted captured frames according to the pulse rate.

In some implementations a low storage memory 216 may be included to store instructions for performing the operations described herein. In some implementations, as a backup to sensing control energy pulses, the memory 216 may also include a temporary internal reference of a pulse rate that may provide backup pulse rate in case that control energy pulses are not detected. The memory 216 of the responsive active marker may be configured for light and short term storage, consistent with the simplistic design of the responsive active marker.

In some implementations, the active marker unit may include one or more processors 214 that use logic to perform operations for instructions stored in memory 214.

The responsive active marker 104 may be locally powered. For example, the responsive active marker 104 may include a power source 210, such as a non-rechargeable or rechargeable coin cell battery. In some implementations, the power source 210 provides in-use time of 1 hour to several hours, e.g., two hours or more, and standby time of longer, e.g., at least two days.

In some implementations, all of the responsive active markers in a live action scene may pulse energy at the same rate as the sensor device exposure time, e.g., 1.0 msec., such that energy source is switched on to emit energy by each active marker unit only during the time period that the shutter is open and turn off to not emit energy when the shutter is closed. In this manner, less information may be needed to detect and process energy received from each responsive active marker than systems in which each markers pulse in different pulse rates. For example, only a portion of the exposure time e.g., the time period when the shutter initially opens, may be needed to detect energy pulses, such as the first ⅙^{th} of the exposure time. Less information may be acquired and less memory may be needed to store information from shorter processing times, e.g., 4 bits of information.

In some implementations, the pulse rate of the responsive active marker may be at a variety of rates relative to frame rate of the sensor device, such as energy emission every other frame, and more than once per frame. In some implementations, the energy may be emitted at regular and even intervals during the duration of the camera exposure time.

In some implementations, the wireless active marker 104 may include an alert source that projects a warning indication of operational problems with the wireless active marker 104 in addition to the status report. The alert source may include one or more of the illumination sources 202 that sends a different wavelength of energy from the energy pulses. In some implementations, the alert source may be dedicated to sending warnings indications, such as an LED. The alert source on the responsive active marker may be activated by the active marker detecting problems such as low power and failure of a responsive active marker component. In some implementations, the warning indication may include a flash or steady beam of a particular wavelength of visible light, e.g., a red light, to gain the attention of the production staff to the problem. In some implementations, the warning may serve for quick recognition of a problem or potential problem to draw attention to a status report that includes details of the detected problem. An attachment mechanism 230 may enable the responsive active marker to couple to an object (such as 110 in FIG. 1). Various attachment mechanisms 230 may be employed. For example, the attachment mechanism 230 may include one or more components for a hook and loop fastener, adhesive, snap, magnetic components, etc. Typically, the attachment mechanism is detachable from the object, for example, for maintenance or replacement of the responsive active marker.

FIG. 3 is a schematic diagram of an example of a trigger unit 112. The trigger unit may be larger in size than the responsive active markers and include more complex components and features for communication, memory, processing capacity, etc. than a responsive active marker. In implementations in which the control energy pulses of the trigger unit 112 are detected by the performance capture system for use generating marker data, the features and components of the responsive active marker 104 that enable the performance capture system described above, may also apply to the trigger unit 112.

Trigger unit 112 has a housing 332 with one or more energy sources 302, one or more processors 314, memory 316, a controller 318, a receiver 308 for collecting signals, a transmitter 312 for sending data, drive electronics, and a power source 310.

In some implementations, emitted control energy pulses 304 from the energy source 302 passes through a diffuser 306, similar to the responsive active marker 104. The description above for these components of the responsive active marker 104 also apply to the trigger unit 112. The energy source 202 may generate and emit the same wavelength of energy as the responsive active markers 104, or different energy.

The receiver 308 may include an antenna 322 to intercept signals from the signal controller 116 and optionally from the responsive active marker 104. The signal controller 116 may send various parameters to the trigger unit, such as power settings and energy pulse rate. The signal may be encoded with the pulse rate and sent to the receiver 308 on the trigger unit. In some implementations, parameters encoded in the signal may also include commands to change modes such as from active to sleep mode. The trigger unit 112 may be placed at a distance that enables the antenna 222 of the receiver 208 to receive signals from the signal controller 116. For example, the trigger unit may be located up to 50 m from the signal controller 116. In some implementations, the receiver 308 and a transmitter 312 are combined in a single component transceiver.

In some implementations, the trigger unit 112 may be in wired communication with a control unit, for example, on an object in the live action scene. The trigger unit wired to a control unit may receive electromagnetic waves encoded with data that specifies a pulse rate. It this case, the receiver 308 and/or transmitter 312 may be optional on the trigger unit 112.

The pulse rate of energy emanating from the trigger unit may be in synch with global shutter signals and according to the signal controller 122. For example, the pulse rate may be calibrated to be consistent with the exposure time of the sensor devices, so that control energy pulses are emitted only when the sensor device shutter is open, and thus mimicked energy pulses of the responsive active markers are also in sync with the sensor device operation. The use of a pulse rate rather than constant emitting of energy may provide a benefit in reducing energy needs and on-board battery life. The energy may not be emitted when a sensor device shutter is closed and energy is undetected.

In some implementations, the trigger unit 112 may also include an attachment mechanism 330, for example to attach to an object bearing the responsive active markers 104, to other items in the live action scene, or to sensor device. The attachment mechanism 330 may be similar to the attachment mechanism 230 of the responsive active marker.

In some implementations, the memory 216 of the trigger unit 112 may store an internal reference 224 of the pulse rate. The internal reference 224 may be pre-loaded onto the memory 216 prior to the recording session, for example by the base station. In some implementations, the memory of the trigger unit may have more capacity than the responsive active marker, for example, due to a larger crystal size. The internal reference 224 may be more reliable than for a responsive active marker.

In some implementations, the wireless active marker unit performs self-checks on operability of the wireless active marker unit, such as synchronization of emitted energy, and provides alerts if performance is suboptimal. The wireless active marker unit communicates with various visual production system components, for example to transmit status reports and to receive signals for a pulse rate in which to emit energy, e.g., light. The active marker unit may provide real-time feedback on the status of the active marker operations by sending the status reports, which may include alerts when actual or potential suboptimal performance is detected by the active marker unit. Some examples of such implementations are described in U.S. Provisional Patent Application No. 63/303,454, filed on Jan. 26, 2022, the contents of which is incorporated herein by reference.

In some implementations, an alert on the trigger unit may include other mechanisms to signify a problem with the trigger unit or with the responsive active marker(s) as detected by the trigger unit. The trigger unit may include a problem detector that monitors the responsive active marker for performance issues. For example, an alert source may include one or more of the energy sources 202 that sends a different wavelength of energy from the energy pulses as a warning indicator. The illumination alert may be produced in addition to, or in place of, transmission of a status report.

The trigger unit may also include a transmitter 208 to send information, for example, status reports and alerts to the base station 128, to other active marker units, and/or to the signal controller 122. For example, the trigger unit may provide an alert message or signal to the signal controller 122 and/or performance capture system 120 in case of an event (e.g., adverse condition), such as low battery or other conditions that may affect function. The alert may trigger the active marker unit and/or controller to change the wavelength of energy being emitted.

In some implementations, the active marker unit may include one or more processors 214 that perform operations for instructions stored in memory 214. For example, the instructions may enable controller 218 to direct the emitting of energy at a pulse rate according to received signals. In some implementations, the logic may enable dynamic determining various target energy parameters suitable for current conditions and controlling of the function of the active marker unit to the target energy parameters, such as a target length of time for the energy pulses (e.g., 0.5 msec., 2.0 msec., or 4.0 msec.), an intensity amount, etc., and may adjust the parameters accordingly on the fly. For example, energy intensity may be increased when the marker is exposed to bright light (e.g., outdoor lighting) situations. In another example, the trigger unit may be configured to detect a low battery condition and switch to a power conservation mode, and/or send an alert via a status report to system components, such as the signal controller 122 and/or performance capture system 120.

In some implementations, the trigger unit may transmit status reports, which can include alerts if, for example, the trigger unit may detects a significant drift of the emitted energy from the target energy pulse rate or if power is low for the trigger unit or a responsive active marker. The status report may be transmitted by the trigger unit for a base station to be informed of conditions of the relay system.

In some implementations, a condition sensor on the trigger unit may determine target energy parameters suitable for a current condition and the wavelength of energy may be changed based on the condition. Energy parameters may include wavelength of light, intensity of light, strobing pulse rate of emanating light, etc. Functions of one or more active marker units may be adjusted according to the target energy parameters, such as, emanating a particular wavelength of light, increase or decrease in intensity of the light, increasing or decreasing a portion of diffuser that permits light to emanate or other techniques to change the size of a captured light patch, etc. Sensors may be employed to detect conditions, such as a higher than threshold amount of interfering light, moisture conditions, distance between the trigger unit and the responsive active markers. Other conditions, energy parameters, and functions are possible.

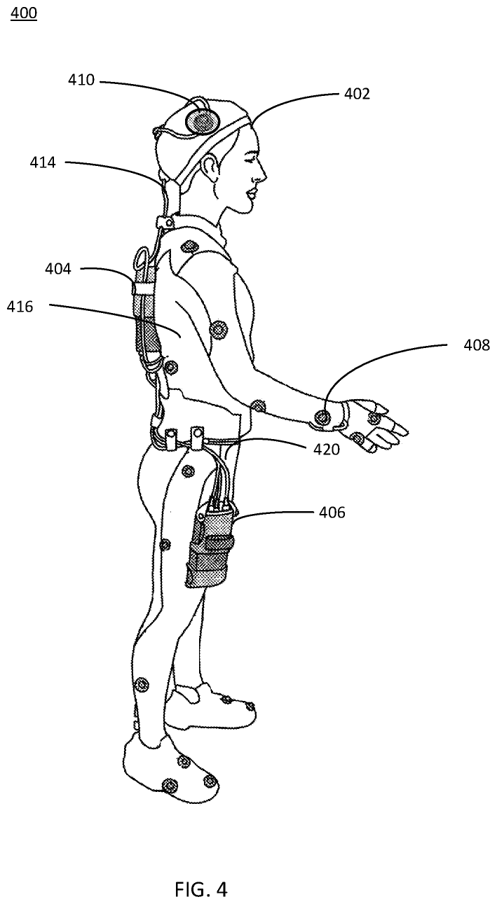

FIG. 4 is a side perspective view diagram of an actor 402 with a wearable article 416 to which is attached an active marker relay system 400. The active marker relay system 400 includes wireless responsive active markers 408 and a wired trigger unit 410 in wired communication with a control unit 404, which may be used for some implementations described herein.

In various implementations, the control unit 404 receives external signals (pulse rate, calibration signals, pattern signals, key sequences, clock signals, etc.) via a transceiver 406 and electrically communicates to trigger unit 410 through wired strands 410. The strands 414 may externally attached to wearable article 416 or may be channeled underneath a wearable article 416. The trigger unit 410 emits control energy pulses that are picked up by the responsive active markers 408 to trigger the responsive active markers 408 and provide guidance on a pulse rate for the responsive active markers 408 to emit energy pulses for performance capture.

The transceiver 406 includes an antenna to receive signals, e.g., from the signal controller. The transceiver 406 may further include one or more cables 420, which may include output cables and input cables to couple the transceiver 406 to the control unit 404. For example, the receiver may receive analog signals in the form of radio frequency signals and transfer the analog signals through output cables 420 to the control unit 404 for conversion to digital signals. In some implementations, the transceiver may receive power through cables 420 from a battery in the control unit 404 or the transceiver may include its own internal power source.

In some implementations, the transceiver 406 may include input cable 420 to receive data from the control unit 404 and transmit the data, e.g., radio frequency signals, to other components of the data capture system, such as the sync controller (116 in FIG. 1), the performance capture system (120 in FIG. 1) and/or the base station (130 in FIG. 1). For example, control unit 404 may provide the transceiver 406 with information such as low power, or malfunction of a component, etc. In some implementations, the base station (e.g., 130 in FIG. 1), via software running on the computing device) receives the information from the transceiver 406 and may process the information. The transceiver 406 may be secured to the wearable article 416 by a pouch, straps, snaps, zippers, etc.

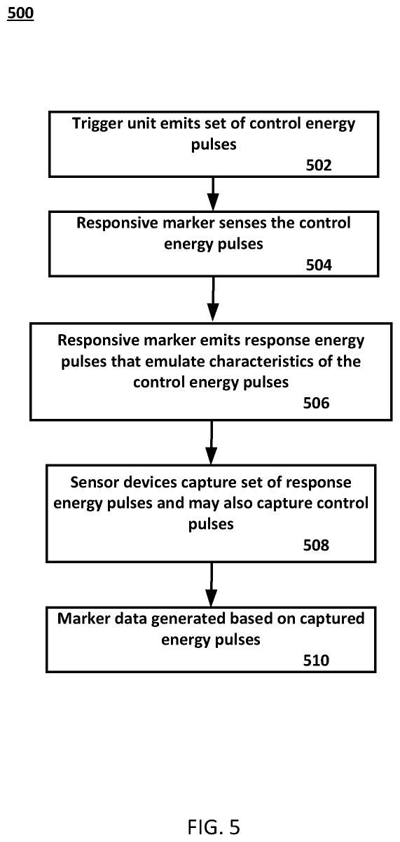

FIG. 5 is a flowchart of a method 500 to operate active markers, via a trigger unit that relays energy pulse information to responsive active markers. The trigger unit is provided in the live action scene.

In block 502, the trigger unit emits control energy pulses, which have various characteristics. For example, the control energy pulses may be emitted at a predefined pulse rate. In some implementations, the trigger unit may receive signals for the pulse rate from a signal controller. The control pulse, energy is emitted by the trigger unit in response to received signals according to the pulse rate.

In block 504, responsive active markers sense the emitted control energy pulses. In some implementations, sensing of the control energy pulses includes detecting characteristics of the control pulses. For example, the responsive active marker may include one or more filters that facilitate sensing particular wavelengths, or ranges of wavelengths of energy and not sensing other wavelengths of energy. Select frequencies of visible light or non-visible light, such as infrared, ultraviolet radiation, may be sensed.

In block 506, the responsive active markers emit response energy pulses that emulate at least some characteristics of the control energy pulses. For example, the control energy pulses may be sensed at a particular pulse rate and trigger emitting of response energy pulses at the same pulse rate. Emulating of the control energy pulses may enable control over the initiation of response energy pulses, as the responsive active marker initiates emissions when the control pulses are sensed. Emulating of the control energy pulses may also enable control over the termination and duration of the response energy pulses, as the responsive active marker stops emitting the response energy pulses when the control pulses cease to be sensed.

In block 508, sensor devices of the performance capture system capture response energy pulses from the responsive active marker unit(s). In some implementations, the trigger unit may serve as an active marker and the control energy pulses may also be captured by the same or different sensor devices for performance capture information.

In block 510, the performance capture system generates marker data based on the captured response energy pulses, and in some implementations on captured control energy pulses.

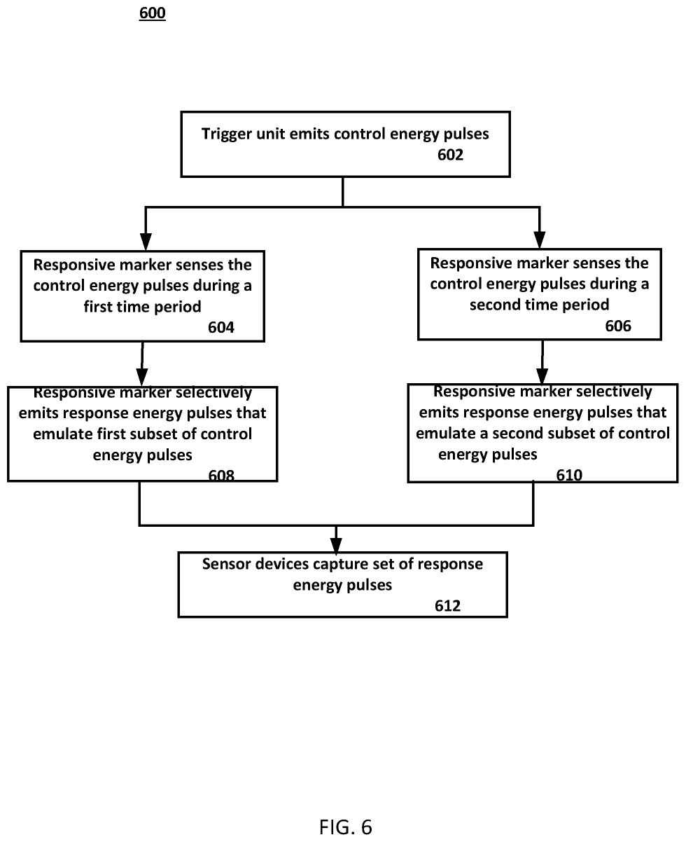

The flowchart in FIG. 6 shows a method 600 to operate active markers, in which responsive active markers selectively respond to sensed control pulses. In block 602, the trigger unit emits control energy pulses. The emitting of the control energy pulses occurs over a stretch of time that includes a first and second time period. The responsive active marker senses the control energy pulses during a first time period in block 604 and a second time period is block 606. In some implementations, the various time periods corresponds with different modes of operation of the responsive active marker.

In the calibration mode, particular devices of the performance capture system may be synchronized to perform individual functions at times consistent with the other devices. For example, the trigger unit and/or responsive active marker may be calibrated such that the pulse rates of the control energy pulses and/or response energy pulses may be consistent with the sensor device exposure time so that light is emitted only when the camera shutter is open. During a diagnostic mode, the functions of particular devices of the performance capture system may be checked for proper operation. During a standard operating mode, energy pulses from the responsive active marker and/or trigger unit may be captured to generate marker data for performance capture.

In block 608 and block 610, the responsive active marker emits response energy pulses that emulate various subsets of the sensed control energy pulses during a respective first time period and second time period. In some implementations, the time periods are non-overlapping and may occur during different modes of operation. For example, during the first time period, a first pattern of control pulses (such as every other pulse) that comprise a first subset of control pulses is responded to by emitting a first set of response energy pulses. During the second time period, a second pattern of control pulses (such as every three pulses) that is different than the first pattern and that comprises a second subset of control pulses are responded to by emitting a second set of response energy pulses. As a result, the first set of response energy pulses may be emitted according to the first pattern and the second set of response energy pulses may be emitted according to the second pattern. At block 612, the sensor device captures the first and second patterns of response energy pulses. In some implementations, an associated computer determines a mode of operation that is associated with the detected patterns of emitted energy pulses.

According to one implementation, the techniques described herein are implemented by one or generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

### Computer Device

As shown in FIG. 7, a computer system 700 may be employed upon which the performance capture system (such as 120 in FIG. 1) may be implemented. The computer system 700 includes a bus 702 or other communication mechanism for communicating information, and a processor 704 coupled with the bus 702 for processing information. The processor 704 may be, for example, a general purpose microprocessor.

In some implementations, the computer system 700 may include marker generation component 732 to produce marker data from the captured energy pulses of the sensor device. In some implementations, the performance capture system may interpolate missing data from data of reliable active marker units on an object. In some instances, the recording session may be paused as the problematic responsive active marker issue is address, for example, recalibrated or the power source is replaced.

The computer system 700 also includes a main memory 706, such as a random access memory (RAM) or other dynamic storage device, coupled to the bus 702 for storing information and instructions to be executed by the processor 704. The main memory 706 may also be used for storing temporary variables or other intermediate information during execution of instructions to be executed by the processor 704. Such instructions, when stored in non-transitory storage media accessible to the processor 704, render the computer system 700 into a special-purpose machine that is customized to perform the operations specified in the instructions.

The computer system 700 further includes a read only memory (ROM) 708 or other static storage device coupled to the bus 702 for storing static information and instructions for the processor 704. A storage device 710, such as a magnetic disk or optical disk, is provided and coupled to the bus 702 for storing information and instructions.

The computer system 700 may be coupled via the bus 702 to a display 712, such as a computer monitor, for displaying information to a computer user. An input device 714, including alphanumeric and other keys, is coupled to the bus 702 for communicating information and command selections to the processor 704. Another type of user input device is a cursor control 716, such as a mouse, a trackball, or cursor direction keys for communicating direction information and command selections to the processor 704 and for controlling cursor movement on the display 712. This input device typically has two degrees of freedom in two axes, a first axis (e.g., x) and a second axis (e.g., y), that allows the device to specify positions in a plane.

The computer system 700 may implement the techniques described herein using customized hard-wired logic, one or more ASICs or FPGAs, firmware and/or program logic which in combination with the computer system causes or programs the computer system 700 to be a special-purpose machine. According to one implementation, the techniques herein are performed by the computer system 700 in response to the processor 704 executing one or more sequences of one or more instructions contained in the main memory 706. Such instructions may be read into the main memory 706 from another storage medium, such as the storage device 710. Execution of the sequences of instructions contained in the main memory 706 causes the processor 704 to perform the process steps described herein. In alternative implementations, hard-wired circuitry may be used in place of or in combination with software instructions.

The term “storage media” as used herein refers to any non-transitory media that store data and/or instructions that cause a machine to operate in a specific fashion. Such storage media may include non-volatile media and/or volatile media. Non-volatile media includes, for example, optical or magnetic disks, such as the storage device 710. Volatile media includes dynamic memory, such as the main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that include the bus 702. Transmission media can also take the form of acoustic or light waves, such as those generated during radio-wave and infra-red data communications.

Various forms of media may be involved in carrying one or more sequences of one or more instructions to the processor 704 for execution. For example, the instructions may initially be carried on a magnetic disk or solid state drive of a remote computer. The remote computer can load the instructions into its dynamic memory and send the instructions over a network connection. A modem or network interface local to the computer system 700 can receive the data. The bus 702 carries the data to the main memory 706, from which the processor 704 retrieves and executes the instructions. The instructions received by the main memory 706 may optionally be stored on the storage device 710 either before or after execution by the processor 704.

The computer system 700 also includes a communication interface 718 coupled to the bus 702. The communication interface 718 provides a two-way data communication coupling to a network link 720 that is connected to a local network 722. For example, the communication interface 718 may be an integrated services digital network (ISDN) card, cable modem, satellite modem, or a modem to provide a data communication connection to a corresponding type of telephone line. Wireless links may also be implemented. In any such implementation, the communication interface 718 sends and receives electrical, electromagnetic, or optical signals that carry digital data streams representing various types of information.

The network link 720 typically provides data communication through one or more networks to other data devices. For example, the network link 720 may provide a connection through the local network 722 to a host computer 724 or to data equipment operated by an Internet Service Provider (ISP) 726. The ISP 726 in turn provides data communication services through the world wide packet data communication network now commonly referred to as the “Internet” 728. The local network 722 and Internet 728 both use electrical, electromagnetic, or optical signals that carry digital data streams. The signals through the various networks and the signals on the network link 720 and through the communication interface 718, which carry the digital data to and from the computer system 700, are example forms of transmission media.

The computer system 700 can send messages and receive data, including program code, through the network(s), the network link 720, and communication interface 718. In the Internet example, a server 730 might transmit a requested code for an application program through the Internet 728, ISP 726, local network 722, and communication interface 718. The received code may be executed by the processor 704 as it is received, and/or stored in the storage device 710, or other non-volatile storage for later execution.

For example, FIG. 7 illustrates the example visual content generation system 700 as might be used to generate imagery in the form of still images and/or video sequences of images. The visual content generation system 700 might generate imagery of live action scenes, computer generated scenes, or a combination thereof. In a practical system, users are provided with tools that allow them to specify details, such as at high levels and low levels where necessary, what is to go into that imagery. For example, a user may employ the visual content generation system 700 to capture interaction between two human actors performing live on a sound stage and replace one of the human actors with a computer-generated anthropomorphic non-human being that behaves in ways that mimic the replaced human actor's movements and mannerisms, and then add in a third computer-generated character and background scene elements that are computer-generated, all in order to tell a desired story or generate desired imagery.

Still images that are output by the visual content generation system 700 might be represented in computer memory as pixel arrays, such as a two-dimensional array of pixel color values, each associated with a pixel having a position in a two-dimensional image array. Pixel color values might be represented by three or more (or fewer) color values per pixel, such as a red value, a green value, and a blue value (e.g., in RGB format). Dimension of such a two-dimensional array of pixel color values might correspond to a preferred and/or standard display scheme, such as 1920 pixel columns by 1280 pixel rows. Images might or might not be stored in a compressed format, but either way, a desired image may be represented as a two-dimensional array of pixel color values. In another variation, images are represented by a pair of stereo images for three-dimensional presentations and in other variations, some or all of an image output might represent three-dimensional imagery instead of just two-dimensional views.

A stored video sequence might include a plurality of images such as the still images described above, but where each image of the plurality of images has a place in a timing sequence and the stored video sequence is arranged so that when each image is displayed in order, at a time indicated by the timing sequence, the display presents what appears to be moving and/or changing imagery. In one representation, each image of the plurality of images is a video frame having a specified frame number that corresponds to an amount of time that would elapse from when a video sequence begins playing until that specified frame is displayed. A frame rate might be used to describe how many frames of the stored video sequence are displayed per unit time. Example video sequences might include 24 frames per second (24 FPS), 50 FPS, 140 FPS, or other frame rates. In some implementations, frames are interlaced or otherwise presented for display, but for the purpose of clarity of description, in some examples, it is assumed that a video frame has one specified display time and it should be understood that other variations are possible.

One method of creating a video sequence is to simply use a video camera to record a live action scene, i.e., events that physically occur and can be recorded by a video camera. The events being recorded can be events to be interpreted as viewed (such as seeing two human actors talk to each other) and/or can include events to be interpreted differently due to clever camera operations (such as moving actors about a stage to make one appear larger than the other despite the actors actually being of similar build, or using miniature objects with other miniature objects so as to be interpreted as a scene containing life-sized objects).

Creating video sequences for story-telling or other purposes often calls for scenes that cannot be created with live actors, such as a talking tree, an anthropomorphic object, space battles, and the like. Such video sequences might be generated computationally rather than capturing energy from live scenes. In some instances, an entirety of a video sequence might be generated computationally, as in the case of a computer-animated feature film. In some video sequences, it is desirable to have some computer-generated imagery and some live action, perhaps with some careful merging of the two.

While computer-generated imagery might be creatable by manually specifying each color value for each pixel in each frame, this is likely too tedious to be practical. As a result, a creator uses various tools to specify the imagery at a higher level. As an example, an artist might specify the positions in a scene space, such as a three-dimensional coordinate system, of objects and/or lighting, as well as a camera viewpoint, and a camera view plane. Taking all of that as inputs, a rendering engine may compute each of the pixel values in each of the frames. In another example, an artist specifies position and movement of an articulated object having some specified texture rather than specifying the color of each pixel representing that articulated object in each frame.

In a specific example, a rendering engine performs ray tracing wherein a pixel color value is determined by computing which objects lie along a ray traced in the scene space from the camera viewpoint through a point or portion of the camera view plane that corresponds to that pixel. For example, a camera view plane might be represented as a rectangle having a position in the scene space that is divided into a grid corresponding to the pixels of the ultimate image to be generated, and if a ray defined by the camera viewpoint in the scene space and a given pixel in that grid first intersects a solid, opaque, blue object, that given pixel is assigned the color blue. Of course, for modern computer-generated imagery, determining pixel colors—and thereby generating imagery—can be more complicated, as there are lighting issues, reflections, interpolations, and other considerations.

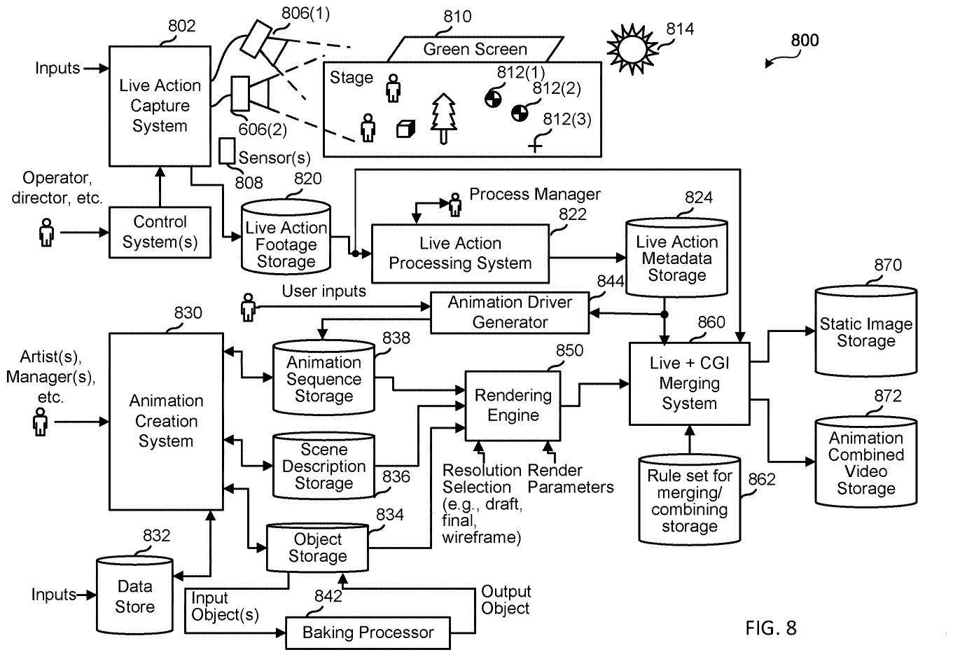

As illustrated in FIG. 8, a live action capture system 802 captures a live scene that plays out on a stage 804. The live action capture system 802 is described herein in greater detail, but might include computer processing capabilities, image processing capabilities, one or more processors, program code storage for storing program instructions executable by the one or more processors, as well as user input devices and user output devices, not all of which are shown.

In a specific live action capture system, cameras 806(1) and 806(2) capture the scene, while in some systems, there might be other sensor(s) 808 that capture information from the live scene (e.g., infrared cameras, infrared sensors, motion capture (“mo-cap”) detectors, etc.). On the stage 804, there might be human actors, animal actors, inanimate objects, background objects, and possibly an object such as a green screen 810 that is designed to be captured in a live scene recording in such a way that it is easily overlaid with computer-generated imagery. The stage 804 might also contain objects that serve as fiducials, such as fiducials 812(1)-(3) that might be used post-capture to determine where an object was during capture. A live action scene might be illuminated by one or more lights, such as an overhead light 814.

During or following the capture of a live action scene, the live action capture system 802 might output live action footage to a live action footage storage 820. A live action processing system 822 might process live action footage to generate data about that live action footage and store that data into a live action metadata storage 824. The live action processing system 822 might include computer processing capabilities, image processing capabilities, one or more processors, program code storage for storing program instructions executable by the one or more processors, as well as user input devices and user output devices, not all of which are shown. The live action processing system 822 might process live action footage to determine boundaries of objects in a frame or multiple frames, determine locations of objects in a live action scene, where a camera was relative to some action, distances between moving objects and fiducials, etc. Where elements are sensed or detected, the metadata might include location, color, and intensity of the overhead light 814, as that might be useful in post-processing to match computer-generated lighting on objects that are computer-generated and overlaid on the live action footage. The live action processing system 822 might operate autonomously, perhaps based on predetermined program instructions, to generate and output the live action metadata upon receiving and inputting the live action footage. The live action footage can be camera-captured data as well as data from other sensors.

An animation creation system 830 is another part of the visual content generation system 800. The animation creation system 830 might include computer processing capabilities, image processing capabilities, one or more processors, program code storage for storing program instructions executable by the one or more processors, as well as user input devices and user output devices, not all of which are shown. The animation creation system 830 might be used by animation artists, managers, and others to specify details, perhaps programmatically and/or interactively, of imagery to be generated. From user input and data from a database or other data source, indicated as a data store 832, the animation creation system 830 might generate and output data representing objects (e.g., a horse, a human, a ball, a teapot, a cloud, a light source, a texture, etc.) to an object storage 834, generate and output data representing a scene into a scene description storage 836, and/or generate and output data representing animation sequences to an animation sequence storage 838.

Scene data might indicate locations of objects and other visual elements, values of their parameters, lighting, camera location, camera view plane, and other details that a rendering engine 850 might use to render CGI imagery. For example, scene data might include the locations of several articulated characters, background objects, lighting, etc. specified in a two-dimensional space, three-dimensional space, or other dimensional space (such as a 2.5-dimensional space, three-quarter dimensions, pseudo-3D spaces, etc.) along with locations of a camera viewpoint and view place from which to render imagery. For example, scene data might indicate that there is to be a red, fuzzy, talking dog in the right half of a video and a stationary tree in the left half of the video, all illuminated by a bright point light source that is above and behind the camera viewpoint. In some cases, the camera viewpoint is not explicit, but can be determined from a viewing frustum. In the case of imagery that is to be rendered to a rectangular view, the frustum would be a truncated pyramid. Other shapes for a rendered view are possible and the camera view plane could be different for different shapes.

The animation creation system 830 might be interactive, allowing a user to read in animation sequences, scene descriptions, object details, etc. and edit those, possibly returning them to storage to update or replace existing data. As an example, an operator might read in objects from object storage into a baking processor that would transform those objects into simpler forms and return those to the object storage 834 as new or different objects. For example, an operator might read in an object that has dozens of specified parameters (movable joints, color options, textures, etc.), select some values for those parameters and then save a baked object that is a simplified object with now fixed values for those parameters.

Rather than have to specify each detail of a scene, data from the data store 832 might be used to drive object presentation. For example, if an artist is creating an animation of a spaceship passing over the surface of the Earth, instead of manually drawing or specifying a coastline, the artist might specify that the animation creation system 830 is to read data from the data store 832 in a file containing coordinates of Earth coastlines and generate background elements of a scene using that coastline data.

Animation sequence data might be in the form of time series of data for control points of an object that has attributes that are controllable. For example, an object might be a humanoid character with limbs and joints that are movable in manners similar to typical human movements. An artist can specify an animation sequence at a high level, such as “the left hand moves from location (X1, Y1, Z1) to (X2, Y2, Z2) over time T1 to T2”, at a lower level (e.g., “move the elbow joint 2.5 degrees per frame”) or even at a very high level (e.g., “character A should move, consistent with the laws of physics that are given for this scene, from point P1 to point P2 along a specified path”).

Animation sequences in an animated scene might be specified by what happens in a live action scene. An animation driver generator 844 might read in live action metadata, such as data representing movements and positions of body parts of a live actor during a live action scene, and generate corresponding animation parameters to be stored in the animation sequence storage 838 for use in animating a CGI object. This can be useful where a live action scene of a human actor is captured while wearing mo-cap fiducials (e.g., high-contrast markers outside actor clothing, high-visibility paint on actor skin, face, etc.) and the movement of those fiducials is determined by the live action processing system 822. The animation driver generator 844 might convert that movement data into specifications of how joints of an articulated CGI character are to move over time.

A rendering engine 850 can read in animation sequences, scene descriptions, and object details, as well as rendering engine control inputs, such as a resolution selection and a set of rendering parameters. Resolution selection might be useful for an operator to control a trade-off between speed of rendering and clarity of detail, as speed might be more important than clarity for a movie maker to test a particular interaction or direction, while clarity might be more important that speed for a movie maker to generate data that will be used for final prints of feature films to be distributed. The rendering engine 850 might include computer processing capabilities, image processing capabilities, one or more processors, program code storage for storing program instructions executable by the one or more processors, as well as user input devices and user output devices, not all of which are shown.

The visual content generation system 800 can also include a merging system 860 that merges live footage with animated content. The live footage might be obtained and input by reading from the live action footage storage 820 to obtain live action footage, by reading from the live action metadata storage 824 to obtain details such as presumed segmentation in captured images segmenting objects in a live action scene from their background (perhaps aided by the fact that the green screen 810 was part of the live action scene), and by obtaining CGI imagery from the rendering engine 850.

A merging system 860 might also read data from a rulesets for merging/combining storage 862. A very simple example of a rule in a ruleset might be “obtain a full image including a two-dimensional pixel array from live footage, obtain a full image including a two-dimensional pixel array from the rendering engine 850, and output an image where each pixel is a corresponding pixel from the rendering engine 850 when the corresponding pixel in the live footage is a specific color of green, otherwise output a pixel value from the corresponding pixel in the live footage.”

The merging system 860 might include computer processing capabilities, image processing capabilities, one or more processors, program code storage for storing program instructions executable by the one or more processors, as well as user input devices and user output devices, not all of which are shown. The merging system 860 might operate autonomously, following programming instructions, or might have a user interface or programmatic interface over which an operator can control a merging process. In some implementations, an operator can specify parameter values to use in a merging process and/or might specify specific tweaks to be made to an output of the merging system 860, such as modifying boundaries of segmented objects, inserting blurs to smooth out imperfections, or adding other effects. Based on its inputs, the merging system 860 can output an image to be stored in a static image storage 870 and/or a sequence of images in the form of video to be stored in an animated/combined video storage 872.

Thus, as described, the visual content generation system 800 can be used to generate video that combines live action with computer-generated animation using various components and tools, some of which are described in more detail herein. While the visual content generation system 800 might be useful for such combinations, with suitable settings, it can be used for outputting entirely live action footage or entirely CGI sequences. The code may also be provided and/or carried by a transitory computer readable medium, e.g., a transmission medium such as in the form of a signal transmitted over a network.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain implementations require at least one of A, at least one of B and at least one of C each to be present.

The use of any and all examples, or exemplary language (e.g., “such as”) provided herein, is intended merely to better illuminate implementations of the invention and does not pose a limitation on the scope of the invention unless otherwise claimed. No language in the specification should be construed as indicating any non-claimed element as essential to the practice of the invention.

In the foregoing specification, implementations of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further implementations can be envisioned to one of ordinary skill in the art after reading this disclosure. In other implementations, combinations or sub-combinations of the above-disclosed invention can be advantageously made. The example arrangements of components are shown for purposes of illustration and it should be understood that combinations, additions, re-arrangements, and the like are contemplated in alternative implementations of the present invention. Thus, while the invention has been described with respect to specific implementations, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

In the foregoing specification, implementations of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further implementations can be envisioned to one of ordinary skill in the art after reading this disclosure. In other implementations, combinations or sub-combinations of the above-disclosed invention can be advantageously made. The example arrangements of components are shown for purposes of illustration and it should be understood that combinations, additions, re-arrangements, and the like are contemplated in alternative implementations of the present invention. Thus, while the invention has been described with respect to certain implementations, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

Although the description has been described with respect to particular implementations thereof, these particular implementations are merely illustrative, and not restrictive. For example, in some implementations, a plurality of image capture devices may be used to capture images from various angles of the same live action scene or to capture different portions of the live action scene and the images may be stitched together or particular images selected for the output image. In various implementations, additional equipment, techniques and technologies may be employed to accommodate requirements of a particular virtual production and live action scene, such as underwater scenes.

Any suitable programming language can be used to implement the routines of particular implementations including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a computer-readable storage medium for use by or in connection with the instruction execution system, apparatus, system, or device. Particular implementations can be implemented in the form of control logic in software or hardware or a combination of both. The control logic, when executed by one or more processors, may be operable to perform that which is described in particular implementations.

Particular implementations may be implemented by using a programmed general purpose digital computer, by using application specific integrated circuits, programmable logic devices, field programmable gate arrays, optical, chemical, biological, quantum or nano-engineered systems, components and mechanisms may be used. In general, the functions of particular implementations can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above. A computer readable medium can comprise any medium for carrying instructions for execution by a computer, and includes a tangible computer readable storage medium and a transmission medium, such as a signal transmitted over a network such as a computer network, an optical signal, an acoustic signal, or an electromagnetic signal.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

We claim:

1. A method for operating active markers for performance capture, the method comprising:
emitting, by a trigger unit, control energy pulses of a first control set, wherein the trigger unit is positioned in a live action scene and proximal to one or more responsive active markers attached to an object in the live action scene;
sensing, by the one or more responsive active markers, the control energy pulses;
in response to sensing the control energy pulses, emitting, by the one or more responsive active markers, response energy pulses of a first response set, wherein the response energy pulses of the first response set emulates at least one characteristic of the sensed control energy pulses;
capturing, by one or more sensor devices, the response energy pulses of the first response set; and
generating marker data based, at least in part, on the captured response energy pulses of the first response set.

2. The method of claim 1, wherein the at least one characteristic of the sensed control energy pulses includes at least one of a pulse rate or an energy wavelength.

3. The method of claim 1, wherein sensing of the control energy pulses of the first control set is with a respective photodiode of the one or more responsive active marker, and
wherein emitting the response energy pulses includes generating electrical current by the respective photodiode consistent with a pulse rate of the sensed control energy pulses, and an energy source of the one or more responsive active markers responds to the electrical current by emitting the response energy pulses at the pulse rate.

4. The method of claim 1, wherein the control energy pulses of the first control set are emitted at a first pulse rate at a first time period and the method further comprises:
emitting, at a second time period, control energy pulses of a second control set from the trigger unit according to a second pulse rate that is different from the first pulse rate;
sensing, by the one or more responsive active markers, the control energy pulses of the second control set; and
in response to sensing the control energy pulses of the second control set, emitting, by the one or more responsive active markers, response energy pulses of a second response set, wherein the response energy pulses of the second response set emulate the second pulse rate of the sensed control energy pulses of the second control set; and
capturing, by the one or more sensor devices, the response energy pulses of the second response set.

5. The method of claim 4, further comprising:
determining, by the trigger unit, a first mode of operation, wherein emitting the control energy pulses of the first control set is in response to determining the first mode of operation; and
determining, by the trigger unit, a second mode of operation, wherein emitting the control energy pulses of the second control set is in response to determining the second mode of operation.

6. The method of claim 4, wherein the control energy pulses of the first control set include a first wavelength of energy and the response energy pulses of the first response set emulates the first wavelength of energy, and
wherein the control energy pulses of the second control set include a second wavelength of energy different from the first wavelength of energy, and the response energy pulses of the second response set emulates the first wavelength of energy.

7. The method of claim 6, further comprising determining environmental conditions by the trigger unit, wherein the first wavelength of energy is selected by the trigger unit based on a determined first environmental condition and the second wavelength of energy is selected based on a determined second environmental condition.

8. The method of claim 1, further comprising:
capturing, by the one or more sensor devices, the control energy pulses of the first control set and generating the marker data is further based on the captured control energy pulses.

9. An active marker relay system, comprising:
a trigger unit positioned in a live action scene and proximal to one or more responsive active markers, the trigger unit comprising:
one or more energy sources to emit control energy pulses of a first control set according to a pulse rate;
the one or more responsive active markers positioned on an object in a live action scene, the one or more responsive active markers comprising:
one or more sensors to detect the control energy pulses;
one or more energy sources to emit response energy pulses of a first response set, responsive to the detected control energy pulses of the first control set, wherein the emitted response energy pulses of the first response set emulate the pulse rate of the detected control energy pulses; and
one or more sensor devices to capture the response energy pulses of the first response set.

10. The active marker relay system of claim 9, wherein the one or more sensors of the respective one or more responsive active markers includes a photodiode to generate electrical current by the photodiode consistent with the pulse rate of the detected control energy pulses, and
wherein the one or more energy sources are configured to respond to the electrical current by emitting the response energy pulses at the pulse rate.

11. The active marker relay system of claim 9, wherein the trigger unit further comprises a processor to execute logic to perform operations including:
determining a mode of operation; and
directing the one or more energy sources to emit control energy pulses at an adjusted pulse rate in response to determining the mode of operation.

12. The active marker relay system of claim 9, wherein the trigger unit further comprises:
a condition sensor that senses one or more characteristics of an environment; and
a processor to execute logic to perform operations including:
determining an environmental condition based on the one or more characteristics; and
selecting a wavelength of the control energy pulses based on the environmental condition.

13. The active marker relay system of claim 9, further comprising a signal controller comprising a transmitter to transmit signals indicating a pulse rate to the trigger unit,
wherein the trigger unit further comprises an antennae to receive the signals from the signal controller.

14. The active marker relay system of claim 9, further comprising a control unit, wherein the trigger unit receives the pulse rate through wired communication with the control unit.

15. The active marker relay system of claim 9, wherein the one or more energy sources of the responsive active marker includes:
one or more first energy sources to emit a first wavelength of energy in response to at least one of the one or more sensors detecting control energy pulses of the first wavelength; and
one or more second energy sources to emit a second wavelength of energy in response to at least a second one of the one or more sensors detecting control energy pulses of the second wavelength.

16. The active marker relay system of claim 9, further comprising a computing device to generate marker data based on the capture the response energy pulses of the first response set.

17. A method for operating active marker units in a live action scene for performance capture, the method comprising:
emitting, by a trigger unit, control energy pulses at a pulse rate, wherein the trigger unit positioned proximal to one or more responsive active markers attached to an object in the live action scene;
detecting, by the one or more responsive active markers, the control energy pulses during a first time period and during a second time period;
in response to detecting during the first time period, emitting, by the one or more responsive active markers, response energy pulses of a first response set during the first time period, wherein the response energy pulses of the first response set emulate a first subset of the detected control energy pulses;
in response to detecting during the second time period, emitting, by the one or more responsive active markers, response energy pulses of a second response set during the second time period, wherein the response energy pulses of the second response set emulate a second subset of the detected control energy pulses, and wherein the first subset and the second subset are different subsets of the detected control energy pulses; and
capturing, by one or more sensor devices, the response energy pulses of the first response set and the second response set.

18. The method of claim 17, wherein the response energy pulses of the first response set indicate a first mode of operation and the response energy pulses of the second response set indicate a second mode of operation.

19. The method of claim 18, further comprising receiving, by the responsive active marker, mode indicator energy pulses from the trigger unit to indicate at least one of the first mode of operation or the second mode of operation.

20. The method of claim 17, further comprising:
capturing, by the one or more sensor devices, the control energy pulses of the control set; and
generating marker data based on the captured control energy pulses.
